(19) United States
(12) Patent Application Publication
(10) Pub. No.: US 2007/0216895 A1
(43) Pub. Date: Sep. 20, 2007

(54) Fine particle measurement apparatus with exhaust purification function

(75) Inventor: Kenji Watanabe, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/495,784

(22) Filed: Jul. 31, 2006

(30) Foreign Application Priority Data
Mar. 15, 2006 (JP) 2006-071273

(51) Int. Cl. G01N 1/00

(52) U.S. Cl. 356/37

(57) ABSTRACT

To provide a fine particle measurement apparatus with an exhaust purification function, which is capable of suppressing an exhaust from having an adverse effect on an environment without degrading the reliability of fine particle measurement. A fine particle measurement apparatus with an exhaust purification function includes a condensation nucleus counter 30 for condensing alcohol together with fine particles 40 in air thereby to enlarge the fine particles 40, and measuring the enlarged fine particles 40, and an exhaust purification device 13 for purifying an exhaust of the condensation nucleus counter 30. The exhaust purification device 13 includes a photocatalytic filter 14, a chemical filter 15 for adsorbing the alcohol, thereby removing the alcohol, a water-type filter 17 for melting the alcohol to remove the alcohol, and a filter 16 for filtering the fine particles 40 contained in the exhaust to remove the fine particles 40.

### BACKGROUND OF THE INVENTION

1. Field of the Invention

The present invention relates to a fine particle measurement apparatus with an exhaust purification function, and more specifically, to a fine particle measurement apparatus with an exhaust purification function preferable for measuring fine particles with a particle diameter of less than 0.1 μm floating in a semiconductor production environment.

2. Description of the Related Technology

Currently, a semiconductor wiring rule has fallen below 0.1 μm, and is falling below 0.065 μm. However, the mainstream of fine particles measurement unit used in a semiconductor factory is a laser-type particle counter that measures fine particles of 0.1 μm or more, which exceeds the wiring rule. Therefore, it is becoming difficult to apply the laser-type particle counter as a monitor for a semiconductor production environment.

On the other hand, a condensation nucleus counter (CNC) capable of measuring fine particles of 0.01 μm is known.

FIG. 12 shows a conventional condensation nucleus counter 30. The condensation nucleus counter 30 includes an alcohol storage part 31, a particle (fine particle) condensation part 32, a capacitor part (electronic cooler for cooling) 33, a laser beam irradiation part 34, and a vacuum aspiration part 35.

An aspiration pipe 36 passing through the alcohol storage part 31 is connected to the particle condensation part 32. A tip end of the aspiration pipe 36 is opened in an outside atmosphere. Furthermore, in a portion of the aspiration pipe 36 which passes through the alcohol storage part 31, a number of holes having an appropriate size to such a degree as not to allow fine particles 40 to leak are provided.

On both sides of the laser beam irradiation part 34, a laser diode 37 and a photodetector 38 are placed. Laser beam emitted from the laser diode 37 is radiated to the fine particle 40 in the air passing through the laser beam irradiation part 34.

The laser beam is reflected from the fine particle 40 to be incident upon the photodetector 38. Consequently, the fine particle 40 is measured. Furthermore, an exhaust pipe 39 for exhaust to the outside is connected to the vacuum aspiration part 35.

In the condensation nucleus counter 30, the air containing the fine particle 40 is aspirated from an opening of the aspiration pipe 36. While the aspirated air is flowing through the aspiration pipe 36, the fine particle 40 contained in the air and alcohol vapor in the alcohol storage part 31 are mixed with each other.

The fine particle 40 mixed with alcohol is cooled in the particle condensation part 32. Consequently, the alcohol is condensed to the fine particle 40 so that the fine particle is enlarged. The air containing the enlarged fine particle 40 is supplied to the laser beam irradiation part 34.

In the laser beam irradiation part 34, laser beam is radiated to the enlarged fine particle 40. The laser beam is reflected from the fine particle 40 to be incident upon the photodetector 38. Consequently, the fine particle 40 is measured.

The air having passed through the laser beam irradiation part 34 and the fine particle 40 contained in the air pass through the vacuum aspiration part 35 and the exhaust pipe 39 to be exhausted outside. Alcohol is condensed to the fine particle 40.

[Patent Document 1] JP 2001-33377 A

[Patent Document 2] JP 2004-37398 A

However, in the conventional condensation nucleus counter 30, the fine particle 40 is exhausted outside with the alcohol condensed thereto, which causes a problem of having an adverse effect on an environment.

A condensation nucleus counter has been also proposed, in which water is condensed to the fine particle to enlarge the particle in place of alcohol. However, water has condensability lower than that of alcohol. Therefore, the use of water has a problem of low reliability for measuring fine particles.

The present invention has been achieved in view of such problems, and its object is to provide a fine particle measurement apparatus with an exhaust purification function which can suppress the exhaust from having an adverse effect on an environment without degrading the reliability of measurement of fine particles.

### SUMMARY OF THE INVENTION

The present invention has adopted the following device to solve the problems.

The present invention comprises,

(1) A condensation nucleus counter for condensing alcohol together with fine particles in air thereby to enlarge the fine particle, irradiating the enlarged fine particle with laser beam, and detecting the laser beam reflected from the fine particle, thereby measuring the fine particle; and

an exhaust purification device for purifying an exhaust of the condensation nucleus counter,

wherein the exhaust purification device has a photocatalytic filter which decomposes the alcohol contained in the exhaust of the condensation nucleus counter by photocatalysis, thereby to remove the alcohol.

According to the present invention, when fine particles enlarged by the condensation of alcohol contained in an exhaust of a condensation nucleus counter passes through a photocatalytic filter, the alcohol condensed to the fine particle is decomposed to carbon dioxide and water by photocatalysis. Consequently, the alcohol is removed from the exhaust, and the exhaust is deodorized. Thus, the exhaust of the condensation nucleus counter can be suppressed from having an adverse effect on an environment.

(2) Further, the present invention comprises:

a condensation nucleus counter for condensing alcohol together with fine particles in air thereby to enlarge the fine particle, irradiating the enlarged fine particle with laser beam, and detecting the laser beam reflected from the fine particle, thereby measuring the fine particle; and

an exhaust purification device for purifying an exhaust discharged from the condensation nucleus counter,

wherein the exhaust purification device has a water-type filter for passing the exhaust of the condensation counter through water, thereby dissolving the alcohol contained in the exhaust in water to remove the alcohol.

According to the present invention, an exhaust of a condensation nucleus counter is allowed to pass through a water-type filter. Consequently, alcohol contained in the exhaust is dissolved in water with the water-type filter to be removed, and the exhaust is deodorized. Thus, the exhaust of the condensation nucleus counter can be suppressed from having an adverse effect on an environment. Regarding the water-type filter, there are a system for allowing an exhaust to pass through a water tank and a system for allowing an exhaust to pass through a water shower (sometimes called a water-type scrubber), and the present invention includes both systems.

(3) Furthermore, the present invention comprises:

a condensation nucleus counter for condensing alcohol together with fine particles in air thereby to enlarge the fine particle, irradiating the enlarged fine particle with laser beam, and detecting the laser beam reflected from the fine particle, thereby measuring the fine particle; and

an exhaust purification device for purifying an exhaust of the condensation nucleus counter,

wherein the exhaust purification device has a chemical filter to adsorb the alcohol contained in the exhaust of the condensation nucleus counter, thereby removing the alcohol.

According to the present invention, the exhaust of the condensation nucleus counter is allowed to pass through the chemical filter, and alcohol in the exhaust adsorbs to the chemical filter is removed, whereby the exhaust is deodorized. Thus, the exhaust of the condensation nucleus counter can be suppressed from having an adverse effect on an environment.

(4) It is preferable that the exhaust purification device has a water-type filter for passing the exhaust of the condensation counter through water, thereby dissolving the alcohol contained in the exhaust in water to remove the alcohol.

According to this structure, the alcohol contained in the exhaust of the condensation nucleus counter is surely removed with a plurality of kinds of filters.

(5) It is preferable that the exhaust purification device has a chemical filter to adsorb the alcohol contained in the exhaust of the condensation nucleus counter, thereby removing the alcohol.

According to this structure, the alcohol contained in the exhaust of the condensation nucleus counter is removed with a plurality of kinds of filters.

(6) It is preferable that the exhaust purification device has a water-type filter for passing the exhaust of the condensation counter through water, thereby dissolving the alcohol contained in the exhaust in water to remove the alcohol, and a chemical filter to adsorb the alcohol contained in the exhaust of the condensation nucleus counter, thereby removing the alcohol.

According to this structure, the alcohol contained in the exhaust of the condensation nucleus counter is removed with a plurality of kinds of filters. Thus, the exhaust purification function is enhanced.

(7) It is preferable that the exhaust purification device has a filter for filtering the fine particle contained in the exhaust of the condensation nucleus counter to remove the fine particle. According to this structure, the fine particle contained in the exhaust of the condensation nucleus counter can be removed.

(8) It is possible to make a structure that the exhaust purification device further has a water-type filter for passing the exhaust of the condensation counter through water, thereby dissolving the alcohol contained in the exhaust in water to remove the alcohol, a chemical filter to absorb the alcohol contained in the exhaust of the condensation nucleus counter, thereby removing the alcohol, and a filter for filtering the fine particle contained in the exhaust of the condensation nucleus counter to remove the fine particle,

wherein the photocatalytic filter, the chemical filter, the filter, and the water-type filter are connected in series to an exhaust port of the condensation counter in this order.

According to this structure, the alcohol contained in the exhaust of the condensation nucleus counter is removed with a plurality of kinds of filters. Furthermore, the fine particle contained in the exhaust is removed with the filter. Thus, the exhaust purification function is further enhanced.

(9) Water of the water-type filter may contain lime. In a photocatalytic filter, alcohol is decomposed to carbon dioxide and water. By placing a water-type filter using water containing lime at a latter stage of the photocatalytic filter, the carbon dioxide is changed to calcium carbonate with lime to be removed.

(10) Further, the present invention comprises:

condensing alcohol together with fine particles in air thereby to enlarge the fine particle, irradiating the enlarged fine particle with laser beam, and detecting the laser beam reflected from the fine particle, thereby measuring the fine particle, with a condensation nucleus counter, and then the fine particle and the alcohol are exhausted outside; and

removing the alcohol contained in an exhaust of the condensation nucleus counter with a photocatalytic filter, a water-type filter, or a chemical filter.

According to the present invention, alcohol contained in an exhaust of a condensation nucleus counter is removed with at least one kind of a filter among a photocatalytic filter, a chemical filter, and a water-type filter, whereby the exhaust is deodorized. Consequently, the exhaust of the condensation nucleus counter can be suppressed from having an adverse effect on an environment.

### BRIEF DESCRIPTION OF THE DRAWINGS

FIG. 1 is a view showing a fine particle measurement apparatus with an exhaust purification function in a first embodiment according to the present invention.

FIG. 2 is a view showing a fine particle measurement apparatus with an exhaust purification function in a second embodiment according to the present invention.

FIG. 3 is a view showing a fine particle measurement apparatus with an exhaust purification function in a third embodiment according to the present invention.

FIG. 4 is a view showing a fine particle measurement apparatus with an exhaust purification function in a fourth embodiment according to the present invention.

FIG. 5 is a view showing a fine particle measurement apparatus with an exhaust purification function in a fifth embodiment according to the present invention.

FIG. 6 is a view showing a fine particle measurement apparatus with an exhaust purification function in a sixth embodiment according to the present invention.

FIG. 7 is a view showing a fine particle measurement apparatus with an exhaust purification function in a seventh embodiment according to the present invention.

FIG. 8 is a view showing a fine particle measurement apparatus with an exhaust purification function in an eighth embodiment according to the present invention.

FIG. 9 is a view showing a fine particle measurement apparatus with an exhaust purification function in a ninth embodiment according to the present invention.

FIG. 10 is a view showing a fine particle measurement apparatus with an exhaust purification function in a tenth embodiment according to the present invention.

FIG. 11 is a view showing a fine particle measurement apparatus with an exhaust purification function in an eleventh embodiment according to the present invention.

FIG. 12 is a view showing a fine particle measurement apparatus with an exhaust purification function according to the conventional example.

### DETAILED DESCTIPTION OF THE INVENTION

Hereinafter, embodiments of a fine particle measurement apparatus with an exhaust purification function according to the present invention will be described in detail with reference to the drawings.

### First Embodiment

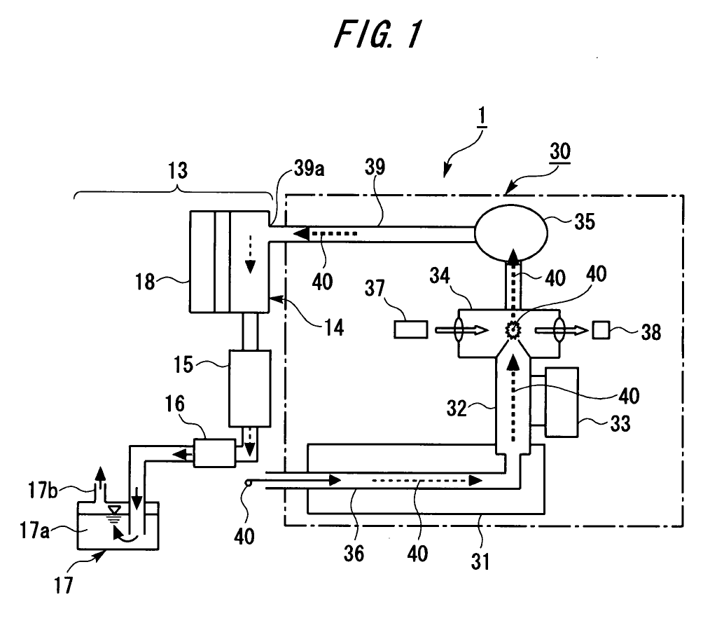

FIG. 1 shows a fine particle measurement apparatus 1 with an exhaust purification function according to a first embodiment of the present invention. The fine particle measurement apparatus 1 with an exhaust purification function includes a condensation nucleus counter 30 for condensing alcohol such as butane to fine particles 40 in air thereby to enlarge the fine particle 40, irradiating the enlarged fine particle 40 with laser beam, and detecting the laser beam reflected from the fine particle 40, thereby measuring the fine particle 40, and an exhaust purification device 13 for purifying an exhaust of the condensation nucleus counter 30.

Furthermore, the exhaust purification device 13 includes a photocatalytic filter 14 for decomposing alcohol contained in the exhaust of the condensation nucleus counter 30 by photocatalysis to remove the alcohol, a chemical filter 15 to adsorb the alcohol contained in the exhaust, thereby removing the alcohol, a filter 16 for precisely filtering the fine particle 40 contained in the exhaust to remove the fine particle 40, and a water-type filter 17 for dissolving alcohol contained in the exhaust in water to remove the alcohol. Regarding the water-type filter 17, there are a system for allowing an exhaust to pass through a water tank and a system for allowing an exhaust to pass through a water shower (sometimes called a water-type scrubber), and the present invention includes both systems. The filter 16 may be exemplified by a filter such as a mechanical or physical filter removing the fine particle 40.

The photocatalytic filter 14 is connected to an exhaust port 39a in an exhaust pipe 39 of the condensation nucleus counter 30. Furthermore, the condensation nucleus counter 30, the chemical filter 15, the filter 16, and the water-type filter 17 are connected in series in this order.

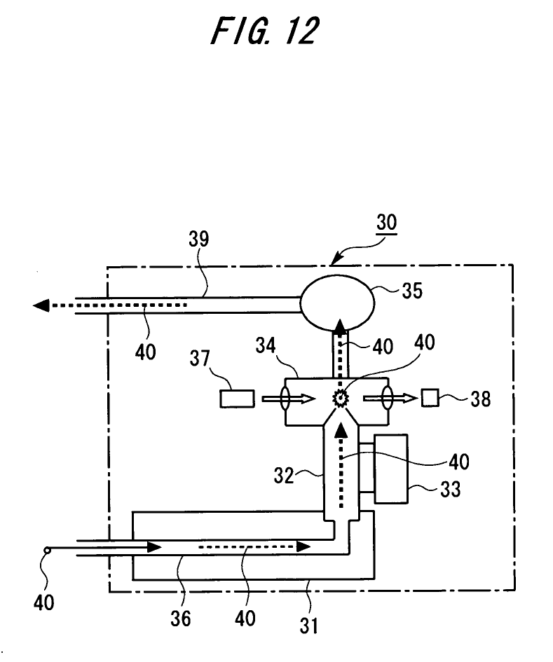

Next, the respective constituting elements will be described. The condensation nucleus counter 30 has the same structure as that described in the conventional example (FIG. 12), so that the detailed description thereof will be omitted.

The photocatalytic filter 14 of the exhaust purification device 13 is provided with an ultraviolet lamp 18. The photocatalytic filter 14 is provided with a filter with a photocatalyst such as titanium dioxide (TiO₂) attached thereto.

The photocatalyst is irradiated with light (ultraviolet light) to generate an OH radical. The OH radical has a strong oxidation force.

When the exhaust of the condensation nucleus counter 30 passes through the photocatalytic filter 14, electrons of alcohol condensed to the fine particle 40 in the exhaust 11 is deprived by the OH radical, whereby alcohol is decomposed to carbon dioxide and water.

Consequently, the alcohol contained in the exhaust of the condensation nucleus counter 30 is removed, and the exhaust is deodorized. As the photocatalytic filter 14, a generally used photocatalytic filter may be used.

In the chemical filter 15, the alcohol condensed to the fine particle 40 contained in the exhaust of the photocatalytic filter 14 is adsorbed to a filter inside the chemical filter 15, so as to be removed.

As the chemical filter 15, a filter using a particle-shaped activated carbon, a fibrous activated carbon, or the like may be exemplified.

In the filter 16, the fine particle 40 contained in the exhaust of the chemical filter 15 is filtered precisely to be removed. As the filter 16, a flat membrane (including a pleat shape) type filter, a small precision filter, and the like may be exemplified.

The water-type filter 17 has a reservoir 17a. The exhaust of the filter 16 passes through water in the reservoir 17a to be exhausted from the exhaust port 17b.

The alcohol contained in the exhaust of the filter 16 is melted in water to be removed when passing through the water-type filter 17. As the water-type filter 17, a generally used filter may be used.

Thus, in the fine particle measurement apparatus 1 having an exhaust purification function of the present invention, the alcohol contained in the exhaust of the condensation nucleus counter 30 is removed with the photocatalytic filter 14, the chemical filter 15, and the water-type filter 17 of the exhaust purification device 13. Consequently, the exhaust of the condensation nucleus counter 30 is deodorized. Furthermore, the fine particle 40 in the exhaust is filtered to be removed with the filter 16.

Accordingly, the exhaust of the condensation nucleus counter 30 can be suppressed from having an adverse effect on an environment. Furthermore, since the condensation nucleus counter 30 is used, the fine particle 40 can be measured exactly, and the reliability of measurement can be maintained. The fine particle measurement apparatus 1 with an exhaust purification function can be used suitably in a clean room.

In the present embodiment, the description has beam made for the case where the water-type filter 17 is provided in a latter stage of the filter 16. As described above, regarding the water-type filter 17, there are a system for allowing an exhaust to pass through water in a water tank and a system for allowing an exhaust to pass through a water shower. According to the present invention, a water-type filter of both systems may be used.

Furthermore, water of the water-type filter 17 can contain lime. It is preferable that the water-type filter 17 using the lime is used with the photocatalytic filter 18, and is placed in a latter stage of the photocatalytic filter 18.

In the photocatalytic filter 18, alcohol is decomposed to carbon dioxide and water. Carbon dioxide generated herein is changed to calcium carbonate with lime contained in water of the water-type filter 17 so as to be removed. Thus, the exhaust purification efficiency is enhanced.

### Second Embodiment

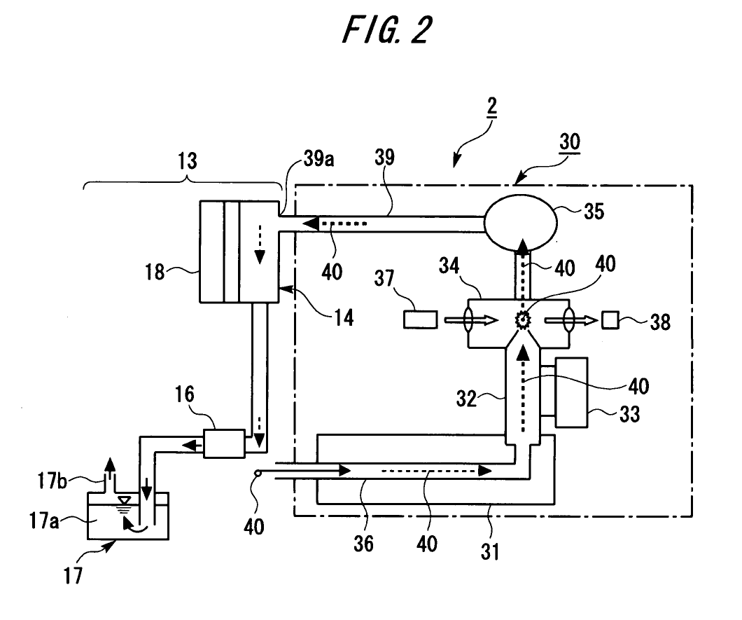

FIG. 2 shows a fine particle measurement apparatus 2 with an exhaust purification function in a second embodiment according to the present invention. In the following description, the same components as those described above are denoted with the same reference numerals as those therein, and the detailed description thereof will be omitted.

In the fine particle measurement apparatus 2 with an exhaust purification function, its exhaust purification device 13 includes a photocatalytic filter 14, a filter 16, and a water-type filter 17. The photocatalytic filter 14, the filter 16, and the water-type filter 17 are connected in series to an exhaust port 39a of a condensation nucleus counter 30 in this order.

In the fine particle measurement apparatus 2 with an exhaust purification function, the alcohol condensed to the fine particle 40 contained in the exhaust of the condensation nucleus counter 30 is removed with the photocatalytic filter 14 and the water-type filter 17. Consequently, the exhaust of the condensation nucleus counter 30 is deodorized.

Furthermore, the fine particle 40 is filtered to be removed with the filter 16. Thus, the exhaust of the condensation nucleus counter 30 can be suppressed from having an adverse effect on an environment.

### Third Embodiment

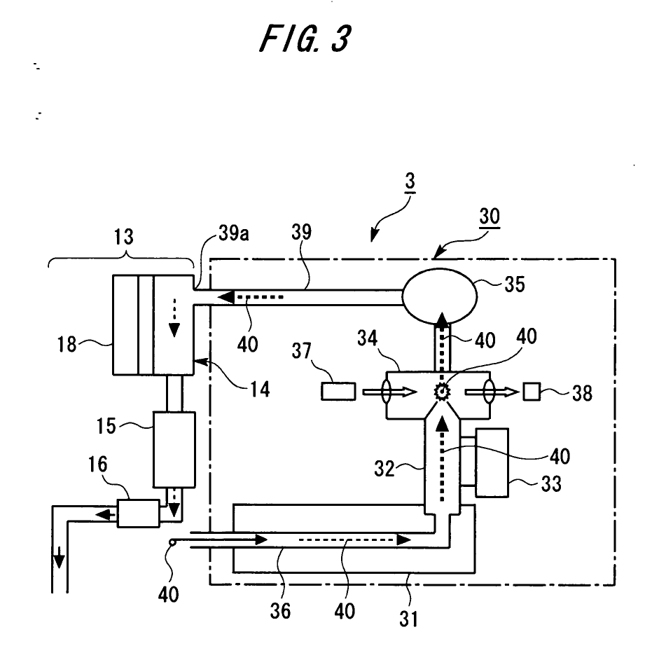

FIG. 3 shows a fine particle measurement apparatus 3 with an exhaust purification function in a third embodiment according to the present invention.

In the fine particle measurement apparatus 3 with an exhaust purification function, an exhaust purification device 13 includes a photocatalytic filter 14, a chemical filter 15, and a filter 16. The photocatalytic filter 14, the chemical filter 15, and the filter 16 are connected in series to an exhaust port 39a of a condensation nucleus counter 30 in this order.

In the fine particle measurement apparatus 3 with an exhaust purification function, the alcohol contained in the exhaust of the condensation nucleus counter 30 is removed with the photocatalytic filter 14 and the chemical filter 15. Consequently, the exhaust of the condensation nucleus counter 30 is deodorized. Furthermore, the fine particle 40 is filtered to be removed with the filter 16.

### Fourth Embodiment

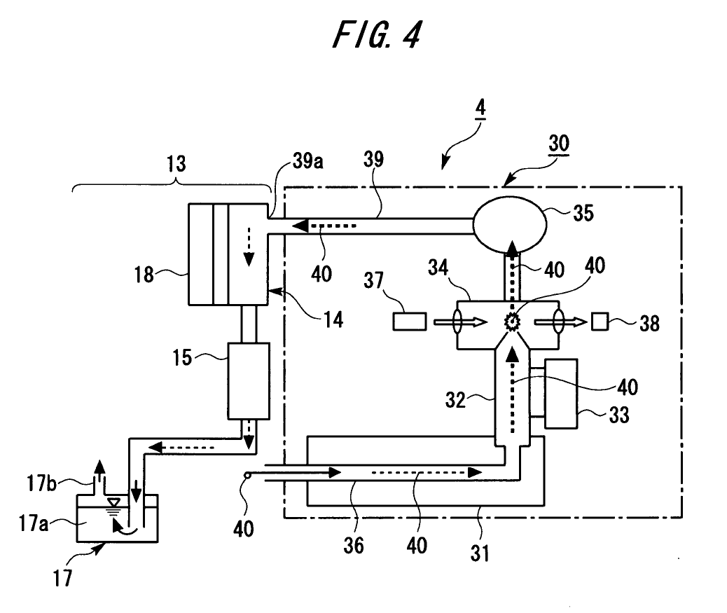

FIG. 4 shows a fine particle measurement apparatus 4 with an exhaust purification function in a fourth embodiment according to the present invention.

In the fine particle measurement apparatus 4 with an exhaust purification function, an exhaust purification device 13 includes a photocatalytic filter 14, a chemical filter 15, and a water-type filter 17. The photocatalytic filter 14, the chemical filter 15, and the water-type filter 17 are connected in series to an exhaust port 39a of a condensation nucleus counter 30 in this order.

In the fine particle measurement apparatus 4 with an exhaust purification function, the alcohol contained in the exhaust of the condensation nucleus counter 30 is removed with the photocatalytic filter 14, the chemical filter 15, and the water-type filter 17. Consequently, the exhaust of the condensation nucleus counter 30 is deodorized.

### Fifth Embodiment

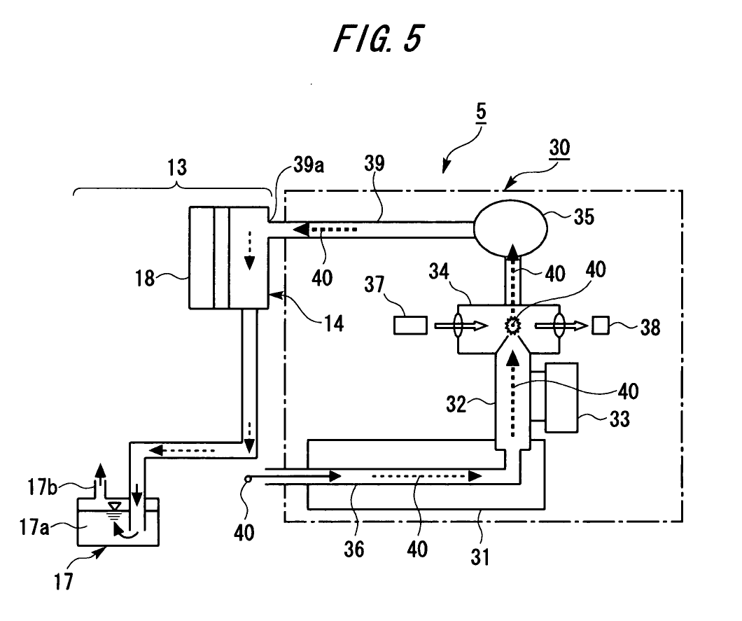

FIG. 5 shows a fine particle measurement apparatus 5 with an exhaust purification function in a fifth embodiment according to the present invention.

In the fine particle measurement apparatus 5 with an exhaust purification function, an exhaust purification device 13 includes a photocatalytic filter 14 and a water-type filter 17. The photocatalytic filter 14 and the water-type filter 17 are connected in series to an exhaust port 39a of a condensation nucleus counter 30 in this order.

In the fine particle measurement apparatus 5 with an exhaust purification function, the alcohol condensed to the fine particle 40 contained in the exhaust of the condensation nucleus counter 30 is removed with the photocatalytic filter 14 and the water-type filter 17. Consequently, the exhaust of the condensation nucleus counter 30 is deodorized. Thus, the exhaust of the condensation nucleus counter 30 can be suppressed from having an adverse effect on an environment.

### Sixth Embodiment

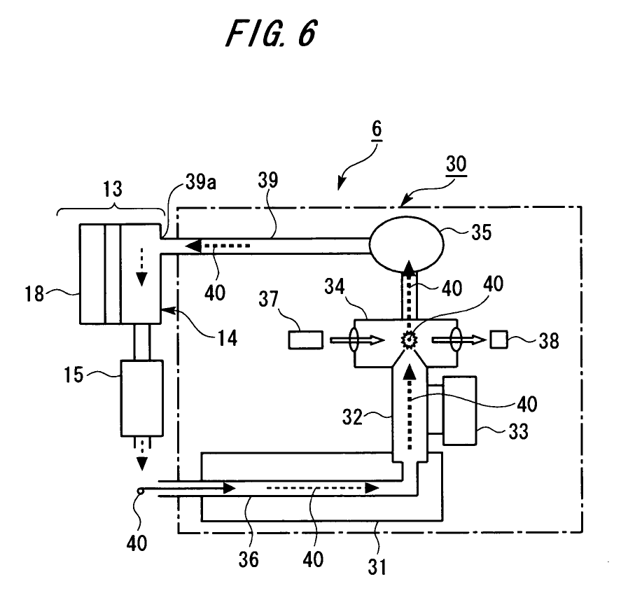

FIG. 6 shows a fine particle measurement apparatus 6 with an exhaust purification function in a sixth embodiment according to the present invention.

In the fine particle measurement apparatus 6 with an exhaust purification function, an exhaust purification device 13 includes a photocatalytic filter 14 and a chemical filter 15. The photocatalytic filter 14 and the chemical filter 15 are connected in series to an exhaust port 39a of a condensation nucleus counter 30 in this order.

In the fine particle measurement apparatus 6 with an exhaust purification function, the alcohol condensed to the fine particle 40 contained in the exhaust of the condensation nucleus counter 30 is removed with the photocatalytic filter 14 and the chemical filter 15. Consequently, the exhaust of the condensation nucleus counter 30 is deodorized. Further, a filter 16 can be placed in a latter stage of the chemical filter 15.

### Seventh Embodiment

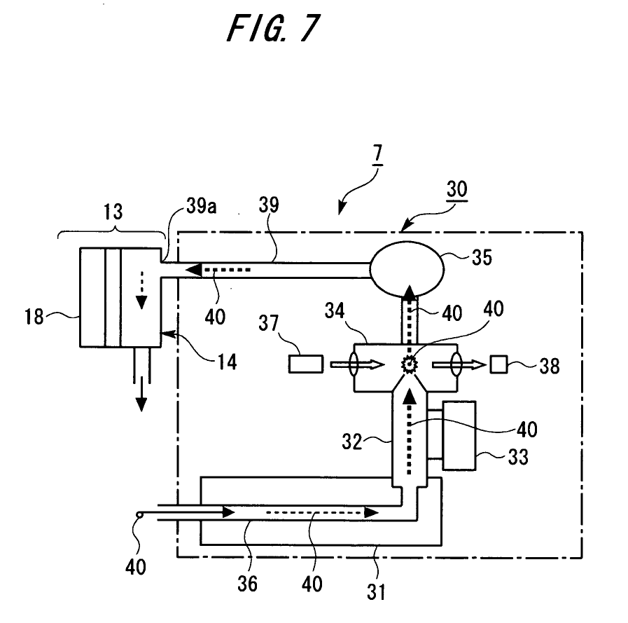

FIG. 7 shows a fine particle measurement apparatus 7 with an exhaust purification function in a seventh embodiment according to the present invention.

In the fine particle measurement apparatus 7 with an exhaust purification function, an exhaust purification device 13 includes a photocatalytic filter 14.

In the fine particle measurement apparatus 7 with an exhaust purification function, the alcohol condensed to the fine particle 40 contained in the exhaust of the condensation nucleus counter 30 is removed with the photocatalytic filter 14. Consequently, the exhaust of the condensation nucleus counter 30 is deodorized. Further, a filter 16 can be placed in a latter stage of the photocatalytic filter 14.

### Eighth Embodiment

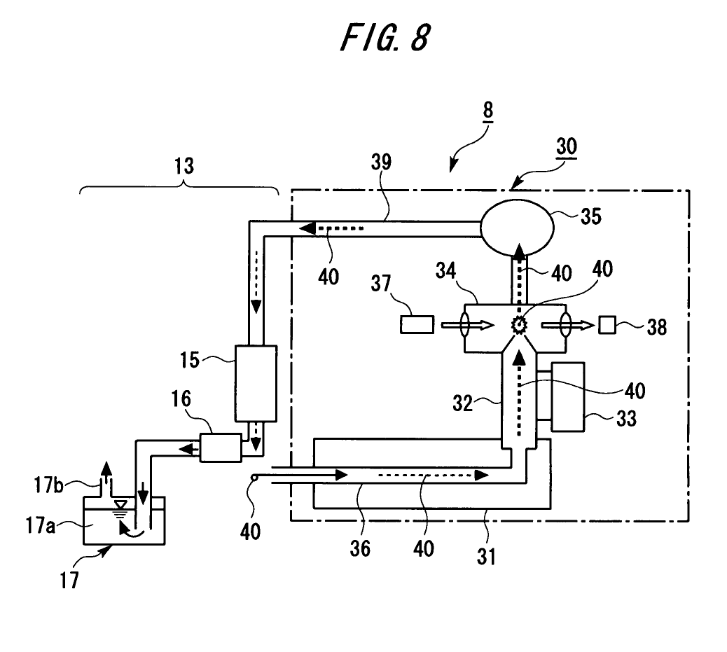

FIG. 8 shows a fine particle measurement apparatus 8 with an exhaust purification function in an eighth embodiment according to the present invention.

In the fine particle measurement apparatus 8 with an exhaust purification function, an exhaust purification device 13 includes a chemical filter 15, a filter 16, and a water-type filter 17. The chemical filter 15, the filter 16, and the water-type filter 17 are connected in series to an exhaust port 39a of a condensation nucleus counter 30 in this order.

In the fine particle measurement apparatus 8 with an exhaust purification function, the alcohol contained in the exhaust of the condensation nucleus counter 30 is removed with the chemical filter 15 and the water-type filter 17. Further, the alcohol condensed to the fine particle 40 contained in the exhaust of the condensation nucleus counter 30 is removed with the filter 16. Consequently, the exhaust of the condensation nucleus counter 30 is deodorized.

### Ninth Embodiment

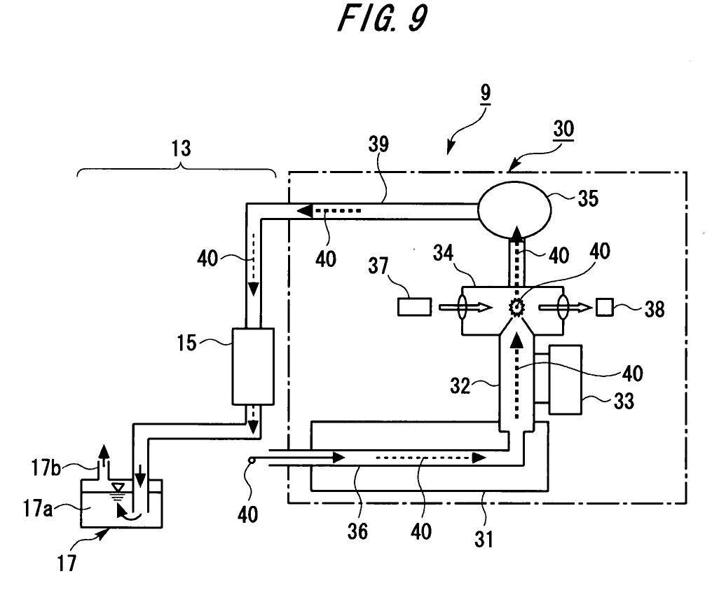

FIG. 9 shows a fine particle measurement apparatus 9 with an exhaust purification function in a ninth embodiment according to the present invention.

In the fine particle measurement apparatus 9 with an exhaust purification function, an exhaust purification device 13 includes a chemical filter 15 and a water-type filter 17. The chemical filter 15 and the water-type filter 17 are connected in series to an exhaust port 39a of a condensation nucleus counter 30 in this order.

In the fine particle measurement apparatus 9 with an exhaust purification function, the alcohol condensed to the fine particle 40 contained in the exhaust of the condensation nucleus counter 30 is removed with the chemical filter 15 and the water-type filter 17. Consequently, the exhaust of the condensation nucleus counter 30 is deodorized.

### Tenth Embodiment

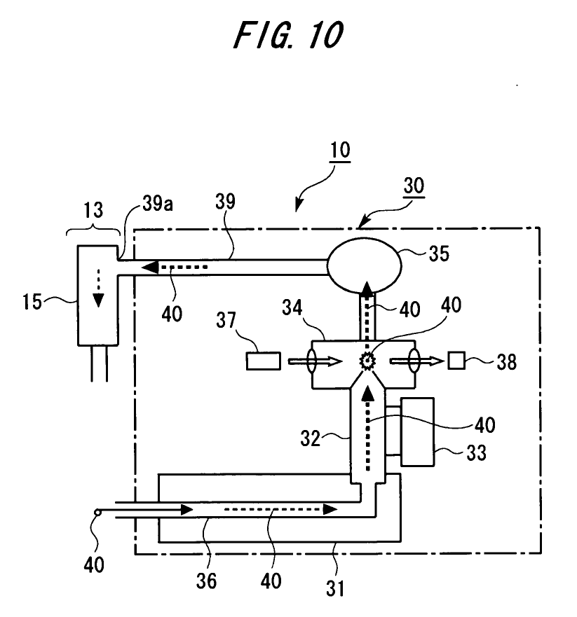

FIG. 10 shows a fine particle measurement apparatus 10 with an exhaust purification function in a tenth embodiment according to the present invention.

In the fine particle measurement apparatus 10 with an exhaust purification function, an exhaust purification device 13 includes a chemical filter 15. The chemical filter 15 is connected directly to an exhaust port 39a of a condensation nucleus counter 30.

In the fine particle measurement apparatus 10 with an exhaust purification function, the alcohol condensed to the fine particle 40 contained in the exhaust of the condensation nucleus counter 30 is removed with the chemical filter 15. Consequently, the exhaust of the condensation nucleus counter 30 is deodorized. Further, a filter 16 can be placed in a latter stage of the chemical filter 15.

### Eleventh Embodiment

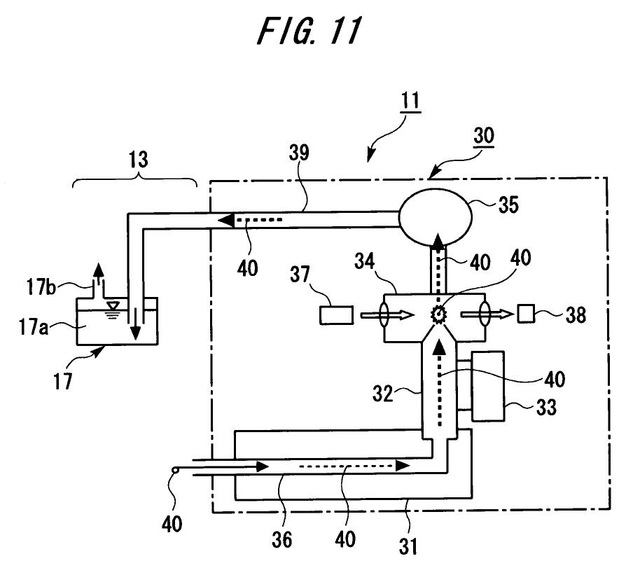

FIG. 11 shows a fine particle measurement apparatus 11 with an exhaust purification function in an eleventh embodiment according to the present invention.

In the fine particle measurement apparatus 11 with an exhaust purification function, an exhaust purification device 13 includes a water-type filter 17. The water-type filter 17 is connected directly to an exhaust port 39a of a condensation nucleus counter 30.

In the fine particle measurement apparatus 11 with an exhaust purification function, the alcohol condensed to the fine particle 40 contained in the exhaust of the condensation nucleus counter 30 is removed with the water-type filter 17. Consequently, the exhaust of the condensation nucleus counter 30 is deodorized. Further, a filter 16 can be placed in a former stage of the water-type filter 17. Furthermore, the respective components of the first to eleventh embodiments can be used in any possible combination.

### <Others>

The disclosure of Japanese patent application No. JP2006-071273 filed on Mar. 15, 2006 including the specification, drawings and abstract are incorporated herein by reference.

What is claimed is:

1. A fine particle measurement apparatus with an exhaust purification function, comprising:
a condensation nucleus counter for condensing alcohol together with fine particles in air thereby to enlarge the fine particles, irradiating the enlarged fine particle with laser beam, and detecting the laser beam reflected from the fine particle, thereby measuring the fine particle; and
an exhaust purification device for purifying an exhaust of the condensation nucleus counter,
wherein the exhaust purification device has a photocatalytic filter for decomposing the alcohol contained in the exhaust of the condensation nucleus counter by photocatalysis to remove the alcohol.

2. A fine particle measurement apparatus with an exhaust purification function, comprising:
a condensation nucleus counter for condensing alcohol together with fine particles in air thereby to enlarge the fine particle, irradiating the enlarged fine particle with laser beam, and detecting the laser beam reflected from the fine particle, thereby measuring the fine particle; and
an exhaust purification device for purifying an exhaust discharged from the condensation nucleus counter,
wherein the exhaust purification device has a water-type filter for passing the exhaust of the condensation nucleus counter through water, thereby dissolving the alcohol contained in the exhaust in water to remove the alcohol.

3. A fine particle measurement apparatus with an exhaust purification function, comprising:
a condensation nucleus counter for condensing alcohol together with fine particles in air thereby to enlarge the fine particle, irradiating the enlarged fine particle with laser beam, and detecting the laser beam reflected from the fine particle, thereby measuring the fine particle; and
an exhaust purification device for purifying an exhaust of the condensation nucleus counter,
wherein the exhaust purification device has a chemical filter for adsorbing the alcohol contained in the exhaust of the condensation nucleus counter to remove the alcohol.

4. The fine particle measurement apparatus with an exhaust purification function according to claim 1, wherein the exhaust purification device further has a water-type filter for passing the exhaust of the condensation nucleus counter through water, thereby dissolving the alcohol contained in the exhaust in water to remove the alcohol.

5. The fine particle measurement apparatus with an exhaust purification function according to claim 1, wherein the exhaust purification device further has a chemical filter for adsorbing the alcohol contained in the exhaust of the condensation nucleus counter, thereby removing the alcohol.

6. The fine particle measurement apparatus with an exhaust purification function according to claim 1, wherein the exhaust purification device further has a water-type filter for passing the exhaust of the condensation nucleus counter through water, thereby dissolving the alcohol contained in the exhaust in water to remove the alcohol, and a chemical filter for adsorbing the alcohol contained in the exhaust of the condensation nucleus counter, thereby removing the alcohol.

7. The fine particle measurement apparatus with an exhaust purification function according to claim 1, wherein the exhaust purification device further has a filter for filtering the fine particle contained in the exhaust of the condensation nucleus counter to remove the fine particle.

8. The fine particle measurement apparatus with an exhaust purification function according to claim 1, wherein the exhaust purification device has a water-type filter for passing the exhaust of the condensation nucleus counter through water, thereby dissolving the alcohol contained in the exhaust in water to remove the alcohol, a chemical filter for adsorbing the alcohol contained in the exhaust of the condensation nucleus counter, thereby removing the alcohol, and a filter for filtering the fine particle contained in the exhaust of the condensation nucleus counter to remove the fine particle,
wherein the photocatalytic filter, the chemical filter, the filter, and the water-type filter are connected in series to an exhaust port of the condensation nucleus counter in this order.

9. The fine particle measurement apparatus with an exhaust purification function according to claim 4, wherein the water of the water-type filter contains lime.

10. A method of measuring fine particles, comprising:
condensing alcohol together with fine particles in air thereby to enlarge the fine particle, irradiating the enlarged fine particle with laser beam, and detecting the laser beam reflected from the fine particle, thereby measuring the fine particle, with a condensation nucleus counter; and
removing the alcohol contained in an exhaust of the condensation nucleus counter with a photocatalytic filter, a water-type filter, or a chemical filter.
